(19) United States
(12) Patent Application Publication
(10) Pub. No.: US 2012/0312203 A1
(43) Pub. Date: Dec. 13, 2012

(54) AERODYNAMIC DEVICE FOR REGULATING TEMPERATURE AND PRESSURE IN A FLUID FLOW CIRCUIT

(76) Inventors: Yves BRAUD, Damvix (FR); Ludovic FERRAND, Saint Germain En Laye (FR)

(21) Appl. No.: 13/489,229

(22) Filed: Jun. 5, 2012

(30) Foreign Application Priority Data
Jun. 7, 2011 (FR) 11 54965

(51) Int. Cl. F23J 15/04; G05D 11/02

(52) U.S. Cl. 110/215; 137/605; 137/3; 137/7

(57) ABSTRACT

A fluid regulator device having means for injecting one or more make-up fluids into a duct conveying the fluid to be regulated. Make-up fluids are injected selectively along at least two orientations. The means for selecting the orientation of injection are situated outside the main duct.

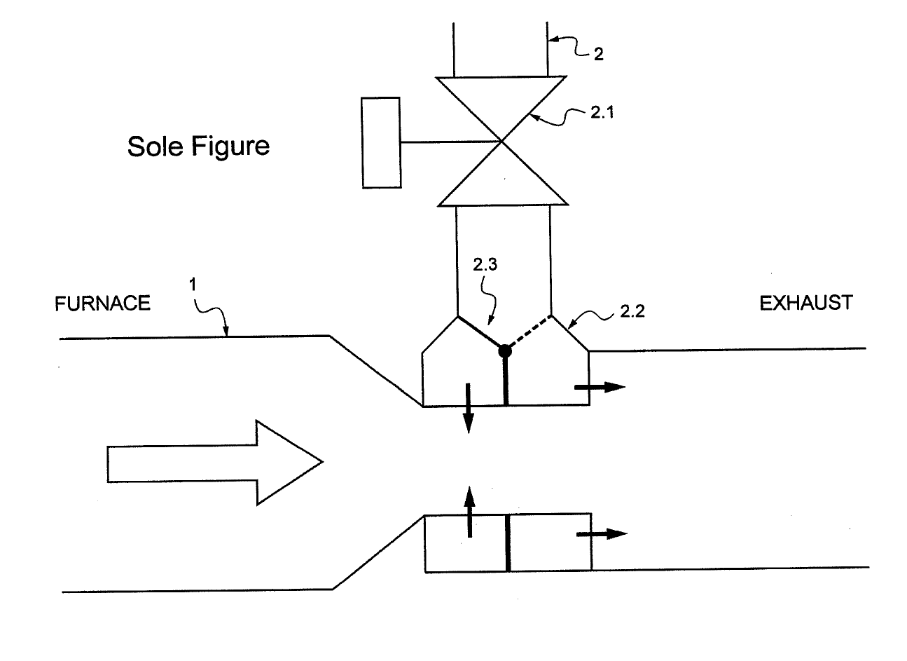

A method of regulating a fluid, the method comprising a step of injecting one or more make-up fluids into a duct that conveys a flow of the fluid that is to be regulated.

### FIELD OF THE INVENTION

The present invention relates to a device for regulating temperature and pressure in a circuit for conveying a flow of a fluid such as flue gases coming from combustion chambers. The device is more particularly intended for use in regulating flue effluents.

### BACKGROUND OF THE INVENTION

Pressure regulator systems are known in the form of dampers, regulators, or valves in which the essential characteristic is that of restraining or releasing the fluid by means of movable members.

Temperature regulator devices are also known making use of heat exchangers that require the fluid to be cooled to be put into contact with a heat exchange surface.

Those types of device are very sensitive to the aggressivity of the fluid that is to be regulated, in particular in the presence of a medium that is corrosive, or clogging, or of fluid temperatures that are high. When subjected to such conditions, the members in contact with the fluid stream are subjected to pitting corrosion, to receiving thick deposits, to jamming, etc. These phenomena quickly render inoperative any regulation system that use members coming into contact with the fluid to be regulated. Solutions for mitigating those weaknesses may include using expensive stainless materials, over-dimensioning actuators, and intensive preventative maintenance. Those responses present the drawback of being relatively expensive.

This is particularly true in the field of exhausting combustion flue gases, and in particular in flue gas circuits and other chimneys arranged at outlets from furnaces.

### OBJECT AND SUMMARY OF THE INVENTION

An object of the invention is to provide fluid regulation means that are protected from the fluid to be regulated.

To this end, the invention provides a fluid regulator device having a main duct for conveying a flow of the fluid that is to be regulated, the duct being fitted with means for injecting at least one make-up fluid into the main duct selectively along at least two orientations. The means for selecting the orientation of the injection are arranged outside the duct.

In the meaning of the present document, the term “make-up fluid” designates any substance that presents fluid behavior. The nature of the make-up fluid, its quantity, the orientation along which it is injected, and also its thermodynamic state variables make it possible to regulate the temperature, the pressure, and the flow rate of the fluid that is to be regulated without exposing sensitive moving members to the stream of the fluid that is to be regulated.

### BRIEF DESCRIPTION OF THE DRAWING

Other characteristics and advantages of the invention appear on reading the following description of a particular, nonlimiting embodiment of the invention.

Reference is made to the sole accompanying figure, which is a diagram of a regulator device in accordance with the invention.

### MORE DETAILED DESCRIPTION

With reference to the figure, the invention is described herein in application to a flue gas exhaust duct connected to a combustion chamber, such as a furnace, in order to exhaust the flue gases to the outside. The exhaust duct is optionally connected to a flue gas treatment device in order to depollute the flue gases before rejecting them into the atmosphere. The flow direction of the fluid is represented by a hollow arrow in the figure.

The regulator device is connected to the duct 1 in order to control the flue gases that constitute the fluid to be regulated.

The regulation may apply to one or more characteristics of the flue gases, such as pressure and temperature. Adjusting the pressure of the flue gases makes it possible to regulate the pressure in the combustion chamber, so as to make its operation safe and prevent any unwanted ingress of air. Regulating pressure may also be effective in compensating for a loss of draft in the exhaust chimney. Adjusting the temperature of the flue gases makes it possible to satisfy anti-pollution standards and also to optimize the operation of the flue gas treatment device when the duct is fitted with such a device.

The device comprises a main duct 1 along which the fluid that is to be regulated flows and having a branch connection to a duct 2 for delivering a make-up fluid. The main duct 1 is connected to the flue gas exhaust duct in order to constitute a portion thereof. The duct 2 is fitted with a feed valve 2.1 and with an injector element 2.2 for injecting the make-up fluid into the main duct 1 in at least two directions.

The injector element 2.2 in this example is constituted by an annular box defining the main duct 1 and having two outlets of different orientations. A first outlet extends perpendicularly to the flow direction of the fluid to be regulated (radial injection), and a second outlet is oriented in the flow direction of the fluid to be regulated (axial injection). The box is fitted with a movable flap 2.3 that is mounted in the box between the two outlets so as to constitute means for selecting the orientation with which the make-up fluid is injected. Opening the valve 2.1 causes a stream of the make-up fluid to be delivered. The movable flap 2.3 directs the stream towards one or the other of the outlets, but it may also feed both outlets simultaneously. The stream of make-up fluid is then split between the two flow directions. The position of the movable flap 2.3 also enables the stream of make-up fluid to be distributed quantitatively between the two outlets. The movable flap 2.3 that is mounted in the box is thus protected from the stream of fluid to be regulated and from any attack therefrom.

The make-up fluid duct 2 is connected to a tank, a fan, a pump, or any other device suitable for delivering the substance at the required flow rate and/or pressure. Devices acting on the temperature of the make-up fluid, such as a heater resistance or a heater tube for passing a flow of hot water and wound helically around the duct, serve to act on the temperature of the make-up fluid. Closing the valve 2.1 puts an end to regulation. The valve may also be used for adjusting the pressure and the flow rate of the make-up fluid.

Regulating the fluid that is to be regulated thus comprises the step of injecting at least one make-up fluid into the duct conveying a flow of the fluid that is to be regulated in such a manner as to modify at least one of the thermodynamic state variables of said fluid, and also comprises a step of selecting a make-up fluid. The nature, the quantity, the orientation, and the thermodynamic state variables (such as pressure, flow rate, temperature) of the make-up fluid are determined as a function of the expected result: lowering temperature by injecting a make-up fluid that is cooler than the fluid to be regulated; raising upstream pressure by radial injection of a fluid at a pressure greater than the pressure of the fluid to be regulated.

Other effects may be obtained by combining orientations, the number of injection points, their distribution, and also parameters relating to the make-up fluid: type, quantity, and thermodynamic state variables.

In this example, flue gas regulation is performed using air under pressure as the make-up fluid.

Naturally, the invention is not limited to the embodiments described but covers any variant coming within the ambit of the invention as defined by the claims.

In particular:

the movable flap 2.3 may be replaced by two valves, a check valve, a slide system, or any other selector means;

the means for orienting the make-up fluids may be implemented by any means that are suitable, and in particular by a check valve, a flap, a slide, a valve, or a steerable nozzle located outside the main duct;

injection orientations may be combined with one another;

injections may be performed at angles that are different from those mentioned, and for example at 10° or 15° relative to an axial direction of the main duct and/or relative to a transverse direction of the main duct;

injection may be performed over all or part of the periphery of the main duct;

injection may be performed by means of a plurality of injection points distributed along the length and periphery of the main duct;

the make-up fluid may be identical to or different from the main fluid;

the branch connection to the duct for conveying the make-up fluid 2 may be made in any orientation; and

particular effects of regulation (increase in flow rate, changing to a laminar flow of the fluid, etc) may be obtained by injecting the make-up fluid tangentially.

1. A fluid regulator device having a main duct for passing a flow of the fluid to be regulated, wherein the device comprises means for injecting at least one make-up fluid into the main duct selectively along at least two orientations, and wherein the means for selecting the orientation of the injection are situated outside the main duct.

2. The device according to claim 1, wherein the means for orienting the make-up fluid are implemented by a check valve, a flap, a slide, a valve, or a steerable nozzle arranged outside the main duct.

3. The device according to claim 1, wherein the injection means are arranged to enable the make-up fluid to be injected substantially radially.

4. The device according to claim 1, wherein the injection means are arranged to enable the make-up fluid to be injected substantially axially.

5. The device according to claim 1, including means for obtaining an increase or a reduction of temperature in the duct by injecting make-up fluid.

6. The device according to claim 1, including means for obtaining an upstream increase or reduction of pressure inside of the duct by injecting make-up fluid.

7. The device according to claim 1, including means for obtaining an increase or a reduction of flow rate in the duct by injecting make-up fluid.

8. A method of regulating a fluid, the method comprising the step of injecting, selectively along at least two orientations, at least one make-up fluid into a duct for conveying a flow of the fluid that is to be regulated in such a manner as to modify at least one of the thermodynamic state variables of said fluid.

9. The method according to claim 8, wherein the thermodynamic state variable that is adjusted is the pressure of the fluid to be regulated.

10. The method according to claim 8, wherein the thermodynamic state variable that is adjusted is the temperature of the fluid to be regulated.

11. The method according to claim 8, wherein the thermodynamic state variable that is adjusted is the flow rate of the fluid to be regulated.

12. The method according to claim 8, including a step of selecting a make-up fluid.

13. A flue including a device according to claim 1.
